(19) United States
(12) Patent Application Publication
(10) Pub. No.: US 2015/0025929 A1
(43) Pub. Date: Jan. 22, 2015

(54) SYSTEM AND METHOD FOR PROVIDING ASSISTANCE

(71) Applicant: WAL-MART STORES, INC., Bentonville, AR (US)

(72) Inventors: Issa M. Abboud, Cave Springs, AR (US); Edwin H. Reed, Bentonville, AR (US); Robert C. Taylor, Rogers, AR (US); Michael Jeffery Galvin, Bentonville, AR (US)

(21) Appl. No.: 14/180,135

(22) Filed: Feb. 13, 2014

Related U.S. Application Data
(63) Continuation-in-part of application No. 13/945,213, filed on Jul. 18, 2013.

(51) Int. Cl. G06Q 30/06; G06Q 10/06

(52) U.S. Cl. CPC G06Q 30/0613; G06Q 10/063114
USPC 705/7.15; 705/26.41; 705/7.13

(57) ABSTRACT

A system is provided that provides customer service functions within a store location. In one implementation, an application is provided that executes on a customer's personal device (e.g., a cell phone) or other store systems (e.g., kiosks) that allows the customer to request assistance from store employees. Such requests may be made that identify a customer's location, and a customer assistance system determines appropriate employee(s) who may service the request. In one implementation, the system may be integrated with a task-based employee management system that communicates tasks to devices used by employees.

### CROSS REFERENCE TO RELATED APPLICATIONS

This application is a continuation-in-part of and also claims priority under 35 U.S.C. §120 to U.S. patent application Ser. No. 13/945,213 entitled “SYSTEM AND METHOD FOR PROVIDING ASSISTANCE”, filed Jul. 18, 2013, which is hereby incorporated by reference in its entirety.

### BACKGROUND

There are many different methods for requesting assistance. For instance, there are systems for requesting support by customers via telephone, on-line assistance such as chat services, email and similar forms of communication.

### SUMMARY

According to one aspect, it is appreciated that it may be useful and particularly advantageous to provide improved methods of servicing support requests while the requestor is within or near a particular location. For instance, it may be desired to render assistance to a customer located at or near a particular retail store location. For instance, it may be helpful for a customer, while he/she is within a retail store, to have the capability of requesting customer service. Such a request may, for example, be serviced based on the customer's location in the retail store.

Such a system may be advantageous for both the retailer and the customer in a number of ways. For instance, according to some embodiments, requests are more quickly responded to by someone that renders specialized customer service (e.g., store personnel, employees, third parties), alleviating the overall amount of time a customer needs to wait for servicing their request. Further, such a capability may be provided using a customer's mobile device, allowing that customer to request more detailed requests. In one example, a customer may receive periodically updated status information regarding their request. For instance, a user may be provided the capability of communicating with a customer assistance system and store personnel using their mobile phone.

It is also appreciated that there may be certain requests that are best serviced by particular employees, third parties, or other entities with specific skills, training or tools. For example, if a customer is in a paint department and is requesting that paint be mixed, only certain employees that have that special training would be needed to fulfill the request. Servicing such requests might include identifying employees with specialized knowledge, such as employees that have knowledge of certain products (e.g., Samsung TVs, etc.), general knowledge (e.g., computers), and/or specialized skills (e.g., making keys). To this end, a system that stores and tracks such employees' skill sets may more suitably and expeditiously match customer requests with employees having the requisite skills to perform the request, as it is appreciated that time is wasted searching for appropriate help. Further, by understanding the long term trends around certain service requests, the organization can make informed decisions as to whether to increase coverage of certain departments at specific times with trained employees, increase training among personnel to develop a larger pool of talent able to perform the specialized tasks, or to deploy additional tools required to deliver the services most desired by its customers.

There may be other tasks that are of a nature that can be serviced by more than one employee. For instance, a customer may need assistance with general information, need help loading purchased items into a vehicle, among other functions. Other requests may be of a more urgent nature, such as reporting a slip or fall within the store, a spill of product within a store, medical emergency or other situation. To this end, the customer assistance system may be capable of determining, based on the request, which employee(s) are the most appropriate to contact. In some cases (e.g., an emergency situation), more than one employee may be contacted simultaneously via targeted broadcast of the service request by the customer assistance system so that prompt assistance may be provided.

Also, the customer assistance system may be integrated with a task-based employee system that is capable of communicating with employees within the retail location and is capable of assigning customer requests to one or more employees. For instance, an order fulfillment system may be leveraged to permit customers to communicate with and have requests assigned to employees. Generally, such systems can be communicated with only by store personnel or by specialized retail systems as part of an order fulfillment process. Other systems such as in-store kiosks, price checking systems and other systems located within the retail location can be leveraged to provide various customer assistance functions as described herein.

Also, according to another aspect of the present invention, the customer assistance system may be used to determine performance (e.g., certain retail stores, locations, customers, departments, etc.) and provide analysis capabilities for management. For instance, the customer assistance system may include a capability that permits a user (e.g., a manager) to determine how long it takes for a particular service request received from a user to be addressed. Also, in another example, the customer assistance system may include a capability that permits a user to determine how long it takes for a particular employee to respond to tasks generated by customer requests. In another example implementation, the customer assistance system may allow management to determine allocations of resources within particular stores based on the numbers and types of requests received and performance data associated with servicing such requests. Such information may contribute to increased levels of customer service.

Further, according to another aspect of the present invention, it is appreciated that such capability may further leverage the capabilities of store employees, as they need not be physically located within the department or location that they are servicing. That is, a single employee may cover a much larger area of the store as they are notified and can respond to customer requests as they occur throughout the store. Such coverage capability is beneficial particularly during off-peak hours, such as during an overnight shift in a 24-hour location.

Depending on the support needed, in-store support may be provided by employees or other entities that are outside of the retail location. For instance, it may be helpful for a customer to speak with an electronics expert which is not available within the physical store location. Such an expert may provide support for multiple retail locations for particular customer support services. This capability may further leverage resources across a number of retail store locations or even larger geographic regions, and may improve customer service level and quality. According to another aspect, the customer assistance system may provide additional capabilities, such as connecting the in-store customer to product specialists and generalists in a more efficient manner. For instance, depending on the customer request, the most appropriate and available employee may be targeted.

Further, the customer assistance system may provide additional information that might relate to the customer, such as instructional information for the customer. For instance, the customer assistance system may provide in-store assistance regarding how to plant a bush, how to paint a wall, or the like. Such information may be in the form of a live person that can provide the information, showing a video (e.g., on the customer's mobile device, a kiosk, etc.), text-based instructions (e.g., shown or emailed to the customer), or other form and/or format.

Also, the customer assistance system may serve as an extension of a customer service department that may provide such services as ordering products, check on items arriving in the store, determining in-stock dates for particular items, providing direction to locations of in-store items and departments, etc. Further, the customer assistance system may be used to provide after-hours help for certain locations/departments/products. For instance, a cell phone counter located within a store may be staffed during certain periods (e.g., 9 AM-5 PM), and when outside of this time period, customer requests received through the customer assistance system may be routed to other employees who may even be located off-site.

According to one aspect, system for assisting a customer at a location is provided. The system comprises a computer system having a memory; a processor coupled to the memory; a location component configured to determine a location of a customer; and an interface having a control that, activated by a customer, contacts a customer assistance system.

In one embodiment, the computer system includes a mobile device of the customer. In one embodiment, the mobile device includes a component adapted to scan a code associated with the location. In one embodiment, the component is adapted to scan a code is responsive to the customer selecting a control that scans the code. In one embodiment, the location component is configured to determine the location of the customer includes at least one of a group of systems used to determine the location comprising at least one of a Wi-Fi component, a GPS component, a network-based location component, an image processing component, and a node-based location component. In one embodiment, the location component is adapted to identify the location of the customer based on a location of a system used to contact the customer assistance system.

In one embodiment, the code associated with the location is a preprinted code that is displayed near the location. In one embodiment, the location is a store location, and wherein the code encodes at least one of a group of information comprising a store location, a store department, an aisle location, a location proximate the store location, a physical location associated with the store and a logical location associated with the store. In one embodiment, the location includes at least one of a group comprising a street address, a poll number, a descriptive address, and a relative location. In one embodiment, the system further comprises an interface adapted to provide location information of the customer to the customer assistance system. In one embodiment, the customer assistance system is adapted to provide one or more assistance options to the user based on the determined location.

In one embodiment, the interface is adapted to present the one or more assistance options to the customer within a display. In one embodiment, the interface includes a control that is configured to accept a choice of the one or more assistance options. In one embodiment, the interface is adapted to receive an input from the customer describing the assistance that is needed. In one embodiment, the customer assistance system is adapted to determine, based on the choice of the one or more assistance options, one or more support resources to fulfill the chosen option. In one embodiment, the one or more support resources include at least one employee. In one embodiment, the customer assistance system is adapted to determine the at least one available store employee based on their on-the-clock availability. In one embodiment, the customer assistance system is adapted to assign one or more support resources to fulfill the chosen option.

In one embodiment, the one or more support resources include personnel resources located at the location. In one embodiment, the one or more support resources include personnel resources located outside of the location. In one embodiment, the system further comprises an interface to a system that assigns at least one task to an employee to be performed to assist the customer. In one embodiment, the system further comprises a component that is adapted to indicate a status of the at least one task to an employee to be performed to assist the customer. In one embodiment, the customer assistance system is adapted to send a request to a task-based employee management system. In one embodiment, the customer assistance system is adapted to send a notification of the at least one task to an employee-based system of an employee assigned to the at least one task. In one embodiment, the customer assistance system is adapted to determine one or more support resources to fulfill the support option responsive to data indicating a capability of an employee to fulfill the chosen assistance option.

In one embodiment, the system further comprises a component that allows the employee to accept the at least one task. In one embodiment, the interface is adapted to display information regarding the employee assigned to the at least one task. In one embodiment, the interface is adapted to display a picture of the employee assigned to the at least one task. In one embodiment, the identification of the employee includes at least one of a name of the employee and a picture of the employee. In one embodiment, the customer assistance system is adapted to determine a performance of the at least one task. In one embodiment, the customer assistance system is adapted to monitor and store performance information relating to the support resources. In one embodiment, the customer assistance system includes an interface that is adapted to report the performance information relating to the support resources. In one embodiment, the customer assistance system is adapted to determine at least one of a group comprising a trend of assistance requests; a trend of types of assistance requests; a performance of at least one employee that handled one or more assistance requests; and a performance of a group of employees that handled one or more assistance requests. In one embodiment, the customer assistance system is adapted to report the performance of one or more stores. In one embodiment, the customer assistance system is adapted to determine an allocation of resources to different store locations.

In one embodiment, the location component is configured to determine a location of a customer within a store. In one embodiment, the performance of the at least one task includes at least one of a measurement of a statistic related to the performance of the at least one task. In one embodiment, the performance of the at least one task includes at least one of an indication that the at least one task was performed. In one embodiment, the system further comprises an interface to a system that presents at least one task that is capable of being accepted by the employee. In one embodiment, the one or more support resources include a responder. In one embodiment, the options displayed are prioritized based on the number of previous requests made from that location. In one embodiment, the options displayed are further prioritized based on the number of previous requests made at a similar time of day as the current request. In one embodiment, the options displayed are further prioritized based on the number of previous requests made on the same day of the week as the current request. According to another embodiment, the interface is adapted to display a map including an indication of the location of the customer. In another embodiment, the interface is adapted to display, on the map, an indication of a location of an employee assigned to a customer service request.

According to one aspect, a method for assisting a customer at a location is provided. The method comprises acts of determining a location of a customer presenting, within an interface of a computer system, a control; and contacting a customer assistance system responsive to a customer activating the control. In one embodiment, the computer system includes a mobile device of the customer. In one embodiment, the mobile device includes a component adapted to scan a code associated with the location of the customer, and the method further comprises an act of determining the location of the code responsive to a scanning of the code by the mobile device. In one embodiment, the component adapted to scan a code is responsive to the customer selecting a control that scans the code. In one embodiment, the act of determining the location of the customer comprises at least one of a group comprising determining the customer location using Wi-Fi, determining the customer location using GPS, determining the customer location using network-based location methods, determining the customer location using image processing, and determining the customer location using node-based location methods. According to one embodiment, the method further comprises an act of identifying the location of the customer based on a location of a system used to contact the customer assistance system. In one embodiment, the code associated with the location is a preprinted code that is displayed near the location. In one embodiment, the location is a store location, and wherein the code encodes at least one of a group of information comprising a store location, a store department, an aisle location, a location proximate the store location, a physical location associated with the store and a logical location associated with the store.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a system for providing customer assistance according to various aspects of the present invention;

FIG. 2 shows a process for providing customer assistance according to various embodiments of the present invention;

FIG. 3 shows another process for providing customer assistance according to various embodiments of the present invention;

FIG. 4 shows yet another process for providing customer assistance according to various embodiments of the present invention;

FIG. 5 shows an example environment in which various aspects of the present invention may be practiced;

FIG. 6 shows an example implementation using a mobile device of a customer to perform an in-store customer assistance function according to one embodiment of the present invention;

FIG. 7 shows one implementation of an interface that may be implemented by a customer assistance system according to one embodiment of the present invention;

FIG. 8 shows another implementation of an interface that may be implemented by a customer assistance system according to one embodiment of the present invention;

FIGS. 9A-9C show additional systems that may be used according to various embodiments of the present invention;

FIG. 10 shows an example computer system with which various aspects of the invention may be practiced; and

FIG. 11 shows an example storage system capable of implementing various aspects of the present invention.

### DETAILED DESCRIPTION

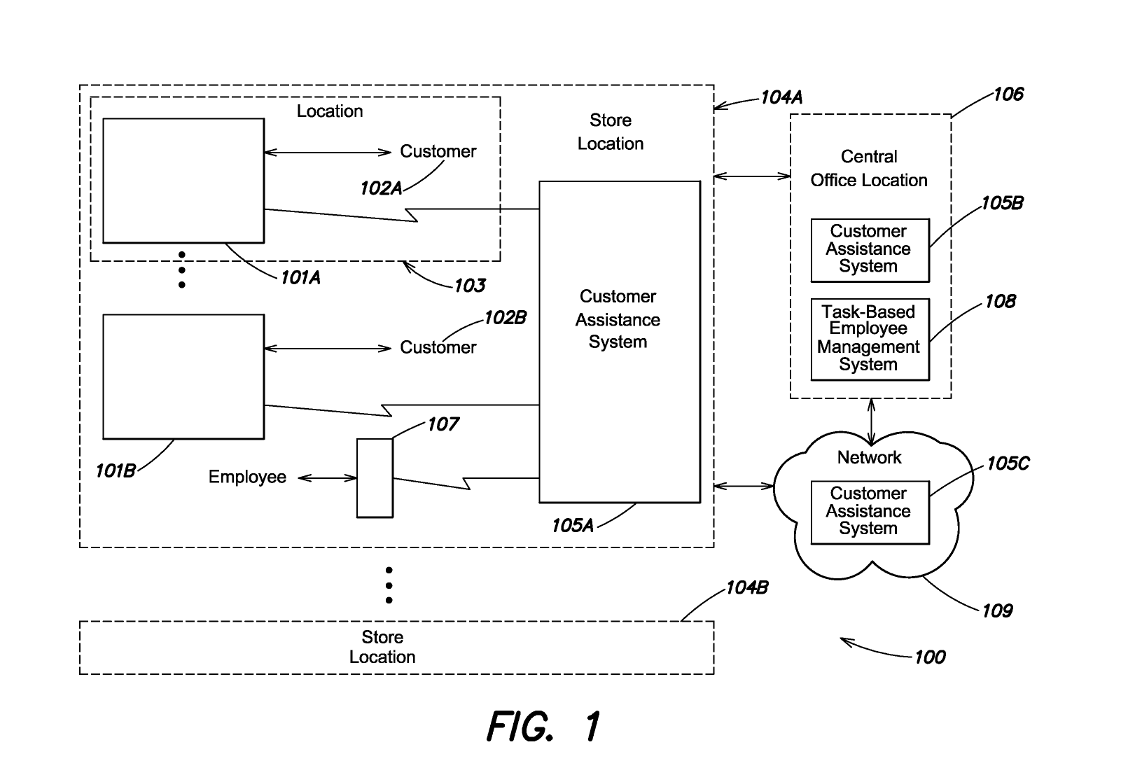

FIG. 1 shows a block diagram of a system 100 suitable for implementing various aspects of the present invention. In particular, according to one embodiment, FIG. 1 shows a system 100 that includes customer assistance system 105 that is capable of implementing various aspects of the present invention.

In one implementation, one or more components of the customer assistance system (e.g., system 105A) may be located and/or operate at a store location (e.g., store locations 104A,104B). For instance, the store location may include a physical store location, and any number of proximate locations (e.g., an adjacent parking lot, a loading dock, a common mall area, etc.). In one example, the employee, the customer, or both may interact with the customer assistance system at any location within the store location. Components of the customer assistance system 105 may be located and/or operate at other locations, such as for example, a central office location (e.g., system 105B at location 106), a home office, another network, hosted system, cloud-based system, distributed among various parts of a distributed computer network (e.g., system 105C within network 109), or the like.

Although various aspects of the present invention may be used by customers and employees at or near a store location, it should be appreciated that certain aspects may be not limited to such implementations. For instance, it should be appreciated that some aspects may be used at any location, by any type of people for the goal of rendering some type of service. For instance, requestors need not be customers (e.g., a person that needs assistance), responders need not be employees (e.g., a volunteer, a third party, etc.) and the location can be any location where service is needed (e.g., in a person's home).

In one embodiment, a customer assistance system may be configured to communicate with one or more customer systems for the purpose of providing assistance within various locations associate with a store. For instance, one or more customers (e.g., customer 102A, 102B, etc.) may operate one or more devices (e.g., devices 101A, 101B) to indicate with a store location that they need assistance. For instance, a customer/user may be provided an application that can be loaded and executed on their personal computing device (e.g., a mobile phone). Alternatively, the customer may operate a kiosk, price checking system, or other system located within the store for the purpose of rendering assistance.

In one embodiment, a personal computing device (e.g., cell phone) may be used to allow the customer to communicate with the store's customer assistance system. For instance, the customer may download an application, launch a browser application, or other application program that permits the customer to indicate to the customer assistance system that they need assistance at or near a store location.

The user may, through the application, indicates to the customer assistance system their location within the store, and based on a request and their location, a task-based employee management system can route an employee to the customer's location to render the desired service. The system the customer operates may indicate the location of the customer and details regarding the type of assistance required to the customer assistance system. For example, the device may use GPS, Wi-Fi, an optical location system, network-based detection methods, device methods, pre-coded locations of devices or any other type of locationing method or combination of methods to determine a customer's location within the store. Also, the customer can operate their phone to scan a code (e.g., a QR code, a barcode or other image) posted within the store, and that barcode or other indicator type may encode the location. In another embodiment, a user may be permitted to enter a location code that may be displayed in a particular location (e.g., code “B4C”, “Loading Dock”, etc.) or select a location from a predetermined number of locations (e.g., as displayed in a menu list of locations).

The location information may be transmitted to the customer assistance system, and based on the request and location, the customer assistance system may provide certain options to the customer for service. Such options may be transmitted to the customer's device, store kiosk or other device, and the user may select among a number of options further refining the type of assistance they desire. The customer may also be permitted to indicate within the interface specifically what type of assistance may be required. Input and selection of options may be in many forms, including natural language input, selection of buttons, checkboxes, links, or any other types of input either alone or in combination with other input types. In one embodiment, the customer assistance system may track the frequency and timing of different request types to better optimize the options presented to the customer for service.

Further, it should be appreciated that a customer assistance system according to one embodiment of the present invention may support multiple store locations (e.g., locations 104A, 104B, etc.). One advantage of using such a system across multiple locations includes having a capability of allocating resources across multiple locations. In one embodiment, resources used outside of locations may be used to provide certain support services within a particular store location.

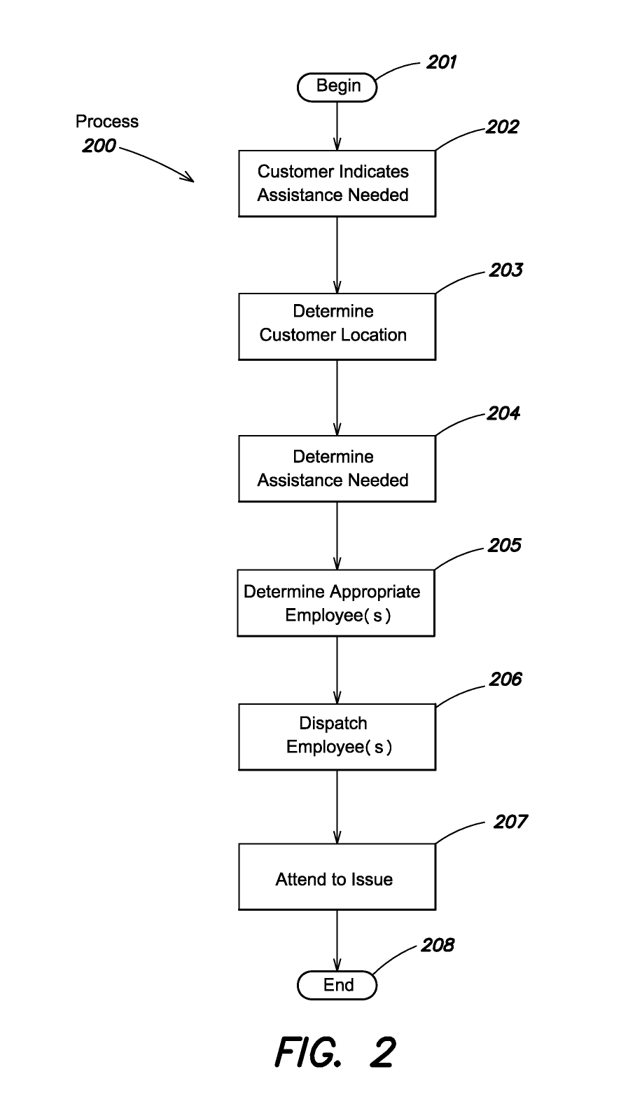

FIG. 2 shows a process 200 for providing customer service according to one embodiment of the present invention. For instance, according to one embodiment, one or more parts of process 200 may be performed by a customer assistance system as described above. At block 201, process 200 begins. At block 201, a customer location at or near a store location is determined. For instance, a mobile device (e.g., a cell phone) may be used to determine location. However, in other embodiments, a user may scan a code placed at a location within the store.

The location information is sent to a customer assistance system that, at block 204, determines the types of assistance the customer is most likely to desire based on their request and the location of the customer. At block 205, the customer assistance system determines one or more appropriate employees that can assist the customer. Such a determination may be made based upon the skills of the employee, the employee's role, the employee's proximate location to the customer, the availability of the employee, the employee's location-based or logical job assignment within the store location, their current on-the-clock status, or other criteria, either alone or in combination with other criteria. At block 206, the customer assistance system tasks one or more employees to perform the service requested. At block 207, the employee(s) attend to the customer's issue, and at block 208, process 200 ends.

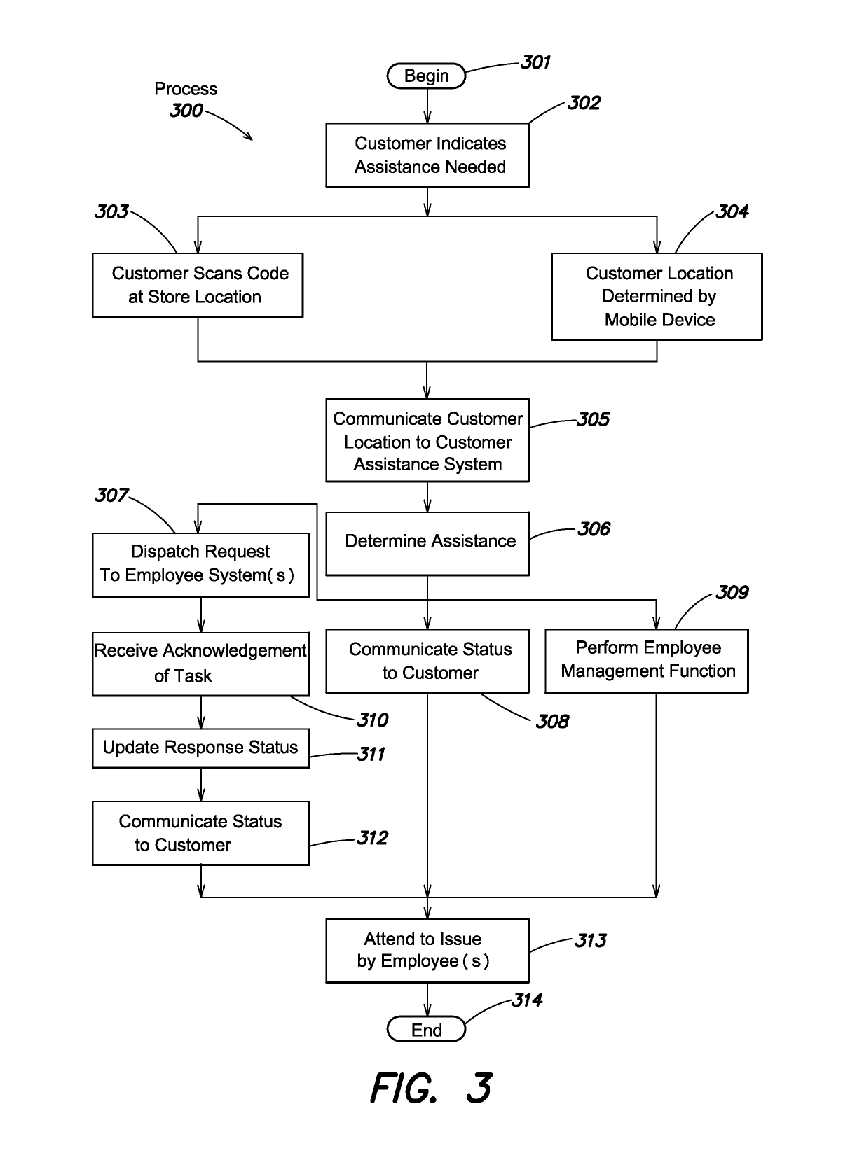

A more detailed process 300 for performing customer service is shown by way of example in FIG. 3. At block 301, process 300 begins. At block 302, a customer indicates that assistance is needed at or near the store location. For instance, as discussed, the customer may scan a code at or near the store location (e.g., at block 303). For instance, the customer may operate a cell phone having a camera that permits the customer to scan a code (e.g., a two-dimensional bar code such as a QR code, etc.) posted within a store location. In another embodiment, the customer location may be determined by a mobile device (e.g., through GPS, cellular network, Wi-Fi, etc., or any combination of methods) at block 304. It should be appreciated that more or less steps may be involved in the process. For instance, in one embodiment, the mere scanning of the code may indicate that both (1) the customer needs assistance/information and (2) an identification of the location of the customer. This may be accomplished, for example, using an application that is capable of reading codes (e.g., a QR code reader) that invokes a web browser program. In one beneficial implementation, a separate application need not be installed on a user's mobile device (e.g., a QR code reader may invoke a web-enabled application).

In an alternative embodiment, the customer may invoke a “help” application loaded on his/her mobile device, and his/her location may be determined by one or more methods, including, but not limited to GPS, cellular network, Wi-Fi, etc. When invoked, the application may determine the location of the customer (e.g., at block 304).

At block 305, the customer location may be communicated to a customer assistance system. For instance, the customer location may be communicated by a customer's mobile device to the customer assistance system through one or more data networks (e.g., cellular, 3G, 4G, Wi-Fi, etc.). At block 306, the customer assistance system may determine the assistance required, depending at least in part on the customer's location. In some cases, location data may not be required to render the service, but it may be otherwise convenient for the customer to have the service provided while at the store location (e.g., to check stock of an item, receive product information regarding a product, receive an answer regarding a particular product, etc.).

The customer assistance system may be capable of performing any number of functions in parallel with any number of customers. For instance, at block 307, the customer assistance system may communicate a request for assistance to one of more employee systems. As discussed above, the customer assistance system may be integrated with a task-based employee management system that provides tasks to store employees to be performed. Tasks may be sent to employee devices that allow the employee to accept tasks and perform them. At block 310, the customer assistance system receives an acknowledgement that a particular task has been accepted. For instance, an employee, within an interface of an employee device may have a control, that when activated by the employee, allows the task-based employee management system to assign the selected task to the employee.

The task-based employee management system may send an acknowledgement message to the customer assistance system indicating that the task has been accepted and assigned to one or more employees. At block 311, the status of the task within the customer assistance system may be updated (e.g., as being assigned and pending). An updated status may be communicated to the customer at block 312. After being assigned, the task and any associated issues may be attended to by the employee (e.g., at block 313). Optionally, the customer may be provided a capability (e.g., within an interface) to cancel one or more customer service requests that they have created. In the case where a customer cancels a request, the customer assistance system may send a request to a task-based employee management to cancel any related employee tasks that were created with the request.

Further, the customer assistance system may perform any number of functions, including but not limited to, communicating the status of the customer assistance request to the customer (e.g., at block 308), perform management functions (e.g., at block 309) including monitoring of employee performance, performing store performance analysis, generating reports to determine allocation of resources within the store or across multiple store locations, or other management functions. At block 314, process 300 ends.

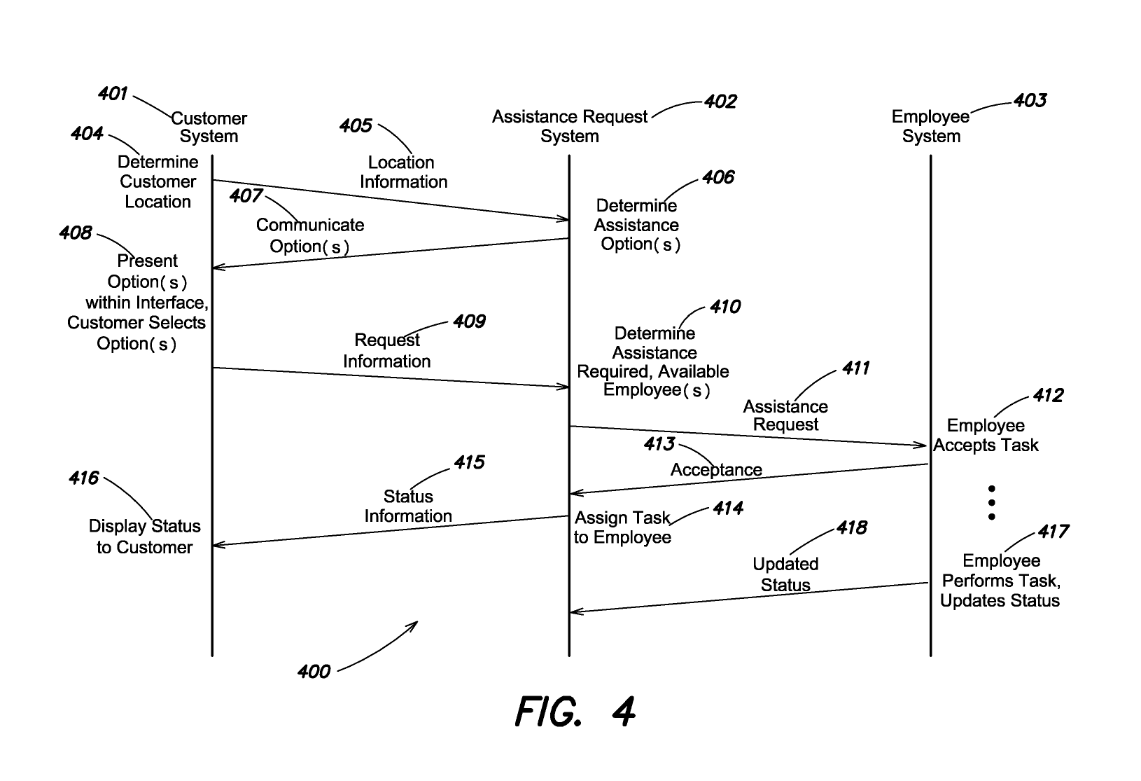

FIG. 4 shows an example process 400 for performing customer assistance using a distributed customer assistance system according to one embodiment of the present invention. In particular, FIG. 4 shows example interactions between a customer system 401, an assistance request system 402, and an employee system 403. For instance, a customer system may include a mobile device of the customer (e.g., a cell phone) or other personal device used to access customer assistance system functions. Alternatively, an in-store system such as a kiosk may be used. Assistance request system 402 may include one or more components of a customer assistance system according to various embodiments of the present invention as described herein. Employee system 403 may include a specially-assigned communication device for the employee, such as a MC9190-G device manufactured by Motorola Corporation. Such a system may be integrated with a task-based employee management system as discussed above for the purpose of assigning tasks and communicating with store systems regarding such tasks. Alternatively, employee system 403 may be any other type of device, such as a cell phone, tablet, laptop, desktop, etc. of the employee that is registered with the task-based employee management system. In such a case, tasks may be communicated to the employee using SMS messages, email, or other methods, as needed.

Process 400 may begin with a determination of the customer's location 404 as discussed above using scanning, device, and/or network-centric methods for determining the customer's location at or near a store location. Such location information (e.g., element 405) may be communicated to the assistance request system 402 such as by transmitting the request within a message communicated over a communication network. The information may be transmitted through any type of network including the store's Wi-Fi network, a cellular-based network with any number of technology types and carriers, Internet, among others.

The assistance request system 402 may determine one or more assistance options 406 such as determining based on the customer's location one or more options to display within their application interface. For instance, there may be one or more common support options based on the customer's location that could be presented to the customer. For instance, the customer is located within the paint department, so one of the determined options may include an option that requests assistance with mixing paint. There may be other options provided, such as ones that have been historically selected from other users while in this department or similar location. Such information may be stored over time by the assistance request system 402 and presented when appropriate to the customer. There may be other options that are general in nature and do not necessarily depend on the particular location, such as a “Product information” option or “Report an emergency” or other type of option.

Such options may be communicated to the customer system 401 and presented to the customer (e.g., at elements 407, 408). The customer may select one or more of the presented options and may provide other information that can be used to create a request for customer assistance. Any request information 409 may be communicated to the assistance request system 402. Based on the option chosen, the assistance request system 402 may determine the assistance required to complete the request, including any tasks that may need to be performed, and may determine any qualified employees that may be available. The assistance request system 402 may send one or more assistance requests 411 to one or more employees via their employee systems 403.

At least one employee accepts the task at 412 using their employee system 403, and acceptance information 413 is communicated to the assistance request system 402. The employee is assigned the task (e.g., element 414). Status information 415 may be communicated to customer system 401, and the status information may be displayed to the customer (e.g., at element 416). For instance, the status information may include a description of the employee assigned to the request, a picture of the employee, name of the employee, estimated time for the employee to attend to the customer (e.g., the employee may be assigned to previous tasks), among other information.

After assignment, the employee may perform the task, and may update the status via their employee system 402. For instance, an interface may be provided by their employee system that permits the status to be updated. The updated status 418 may be communicated to the assistance request system 402. For example, the employee could complete the task and the assistance request system 402 may be notified. In one example, the assistance request system 402 may track multiple customer requests being handled within the store, and an interface may be provided to monitor such requests as they are being handled. A manager or other employee may be capable of reviewing a list of requests to view performance of such requests in real-time. The interface may provide, for example, tasks to be reassigned by a manager (e.g., if the task is not performed within a certain timeframe by an employee, or based on request load on one employee, etc.). In one aspect of the system, the system may include an escalation functionality wherein if a task is not accepted by an employee in a timely manner (e.g., within a predetermined timeframe) or no employee is available to perform the task (e.g., available employees reject the task, no employee is on the clock, etc.), the system may be configured to send the task to a manager, other employee, or group of employees, either in-store or to offsite resources.

Optionally, the customer assistance system may provide one or more additional features that may be used, either alone or in combination with other features. For instance, a store map may be provided that shows the customer location and associate location after the associate accepts the request. In another example, the system may provide real-time location tracking updated on a map for both the customer and the associate until the associate greets the customer in person to assist with the request. In another example, the system may provide an option to use text chat, voice, and/or video methods to communicate between the customer and a local or remote employee for assistance. These options could allow the employee to resolve a request without even having to travel to the physical location.

In yet another example implementation, the system may be adapted to capture the customer's name and/or picture to provide to the associate who is responding to the request. This can be done, for example, using a login to an application program or integration with a social network (such as Facebook or Google+). In another implementation, this feature may be accomplished by requesting the customer to provide their name and/or picture (e.g., a picture chosen from a photo library of the customer's mobile device or a picture taken on the spot with the mobile device's camera), either with or without the necessity to login to an account.

In yet another implementation, the customer assistance system may encourage employee users to “bring your own device” (BYOD) to increase the number of eligible responders and enable higher functionality such as video/voice integration. For instance, an employee may be permitted to use their own smartphone or tablet for accessing the employee interface to the customer assistance system. To this end, a customer assistance system may be configured to only communicate such requests when the employee is actually working or “on-the-clock.” Such a determination may be made using an employee task-based management system or other type of employee management system.

Because store resources may be responsive to more public interfaces, it is appreciated that methods for reducing the amount of wasted calls, nuisance calls, and fraudulent calls may be useful to implement with the customer assistance system. For instance, the customer assistance system may include a security mechanism that is adapted to screen out fraudulent/nuisance use of the system that wastes employee time. This could be accomplished, for example, by requiring the customer to login to a verified profile before sending the request, or by capturing a unique device ID and implementing a lockout mechanism if that device has been reported to engage in raising a certain number of nuisance requests. The customer assistance system could also use the GPS and/or other location-based services to confirm that the customer is physically located within the store or other location, as appropriate. In one implementation, to help prevent nuisance calls, Wi-Fi signals that are known to be in the help location may be used to confirm that the customer is physically located within the store.

In another example use, if the customer request is for product information and/or availability, the customer assistance system may provide an option for the customer to scan a shelf label so the system can provide the product information to the customer. If the item is out-of-stock on the shelf, the customer assistance system could check the store inventory system to see whether the product is available in another location, is located in a back room or other storage location, or is on order for delivery to the store. The interface may also indicate when the product will arrive at the store. In another example, the interface may permit the customer to order the item to be delivered to their home or to be picked up at the store location.

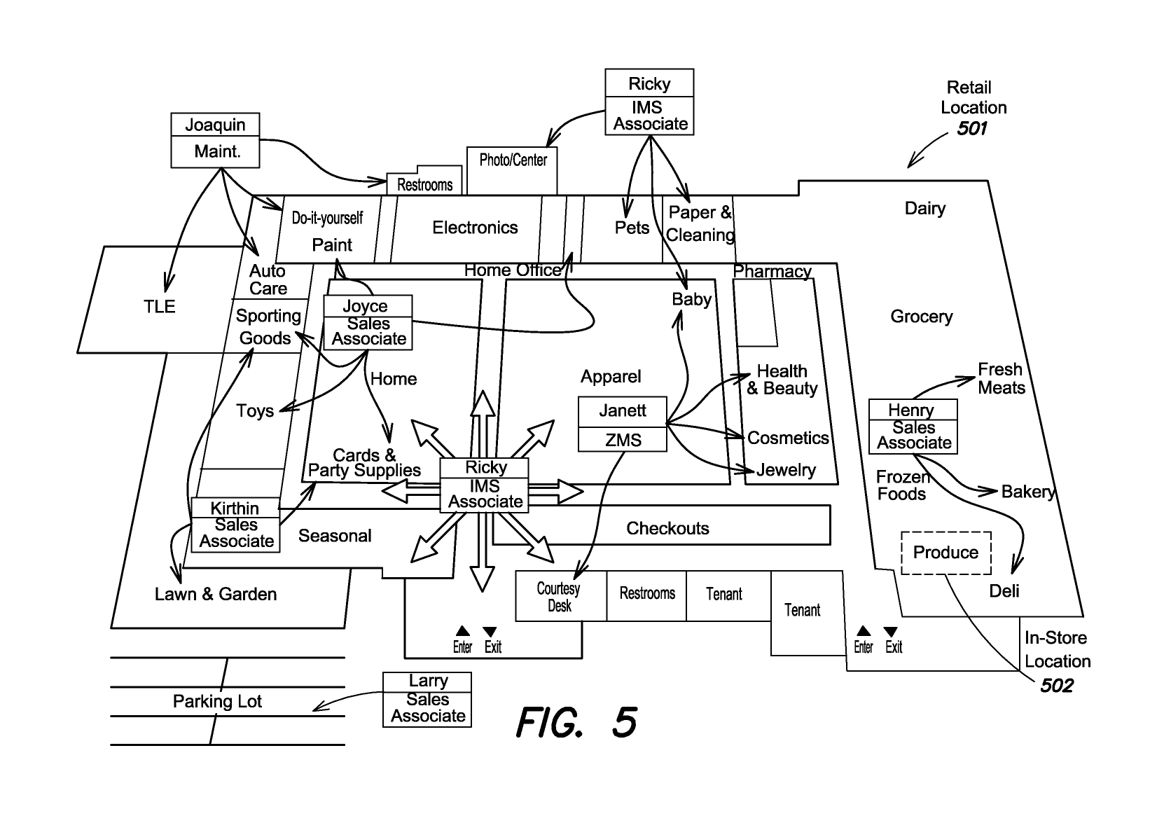

FIG. 5 shows one example of an environment in which various aspects of the present invention may be practiced. For example, a location such as a department store may implement various aspects of the present invention. There may be multiple employees who are each assigned different areas in the store to be “covered” for customer assistance. For instance, sales associate “Henry” may have multiple assigned areas that are covered, including a produce area 502 which is located within the store. Such logical assignments may be tracked by a customer assistance system that associates logical areas of the store with particular employees.

Further, some employees may be assigned to multiple areas. For instance, an employee Janet may be assigned to the courtesy desk as well as jewelry, cosmetics, and other areas of the store. Employees may have “primary” designations for particular locations, may be “backups” in particular areas, or may otherwise have some hierarchical relationship to the area with other employees. For example, there may be an assistant manager that has an overall responsibility to certain areas of the store in which employees have primary assignments. Such relationship information may be stored in a memory of a customer assistance system and may be used to determine an appropriate employee to be assigned to a particular request.

In one embodiment, a hierarchical arrangement of roles is implemented. For instance, there may be a primary role group, a backup role group, and a supervisor group. Employees having a primary designation for a particular area/department or other function may be placed in this group for the particular area/department or function. Similarly, if an employee has a backup role for the particular area/department or function, this designation may be stored. Also, a supervisor group may include those employees designated for a supervisory role. According to one embodiment, the customer assistance system may be configured to escalate a request from the primary group to the backup role group based on one or more criteria (e.g., the request was not accepted before a predetermined time). Further, the customer assistance system may escalate the request from the backup role group to a supervisor group. An employee may have multiple role assignments within the system, and these assignments may change depending on the needs of the store at any point in time.

Certain areas outside the store may also be serviced by the customer assistance system. For example, a parking lot area adjacent to a Lawn and Garden section of the store may be serviced by a salesperson “Larry” as shown in FIG. 5. Other areas related to the store may be serviced by one or more employees such as loading dock areas, common mall areas, walkways, entrances, restroom areas, or other related areas or locations.

Further, there may be certain areas that could be “shared” among multiple employees such as common areas, areas adjacent to their assigned areas, related store areas such as parking lots, loading docks, receiving areas, product receiving lockers, among other areas. Depending on a customer's location, employees may be tasked to go to such locations to assist the customer. Further, depending on the assistance request, the nearest employees may be determined (e.g., by a location-determining network, system, or other method) so that employees may be more efficiently and expediently assigned to particular requests. Further, the requests may be prioritized based on their urgency or relevance (e.g., requests that relate to health and safety, loss prevention, most likely to result in a sale, etc.).

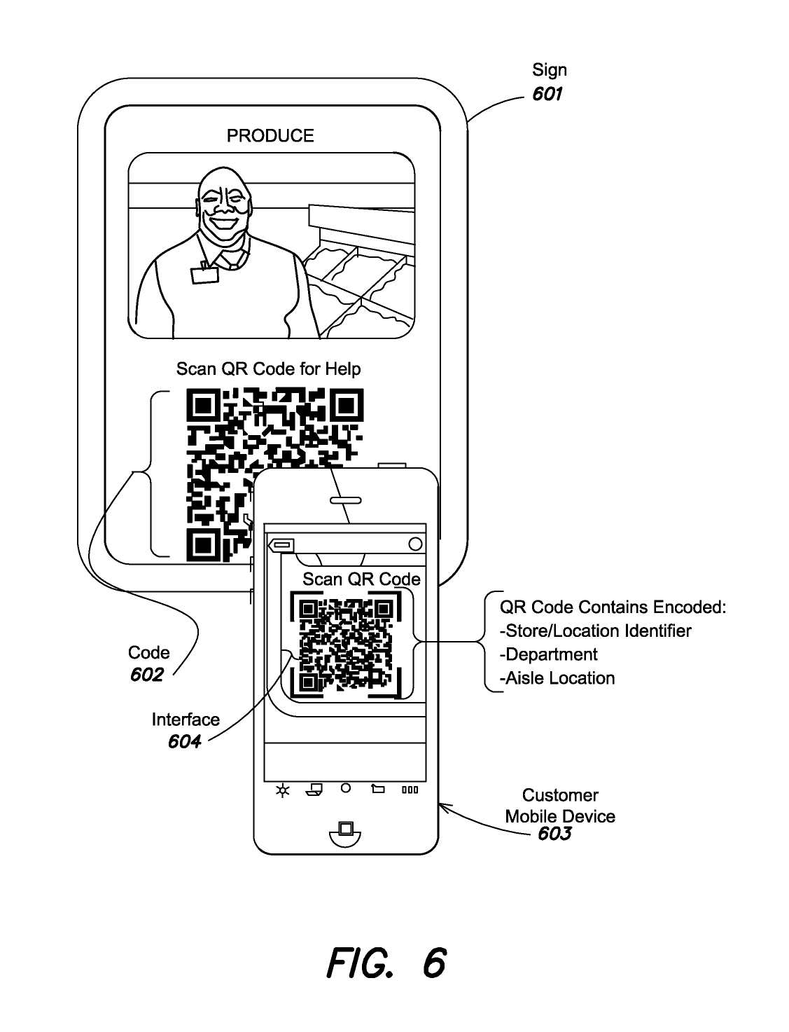

FIG. 6 shows an example implementation using a mobile device of a customer to perform an in-store customer assistance function according to one embodiment of the present invention. For instance, a sign 601 may be posted within a particular location within the store. For instance, within a produce area (e.g., produce area 502), a sign may be posted indicating that a code printed on the sign (e.g., QR code 602) should be scanned by the customer for help. A customer, using an application executing on their mobile device (e.g., mobile customer device 603) scan the displayed code using the mobile device's embedded camera and an interface that permits the customer to align the code within a scan area within the mobile device interface (e.g., interface 604).

According to one embodiment, the code may encode different information, such as a store or location identifier (e.g., to distinguish one store or retail location from another for a system that supports multiple stores or retail locations), a department (e.g., a logical department such as “Produce”) and an aisle location within the store or retail location. Thus, the code may encode physical as well as logical location information. Further, the code may include other encoded information to permit the customer assistance system to determine appropriate service. Also, the displayed code may be scanned by people other than the customer at other times within the service, such as by an employee servicing the request to determine when the employee reaches the location of the customer. The employee may use their scanning device (e.g., on a phone or custom employee device) to scan other information, such as product bar codes to associate particular sales with certain employees that have assisted with a transaction.

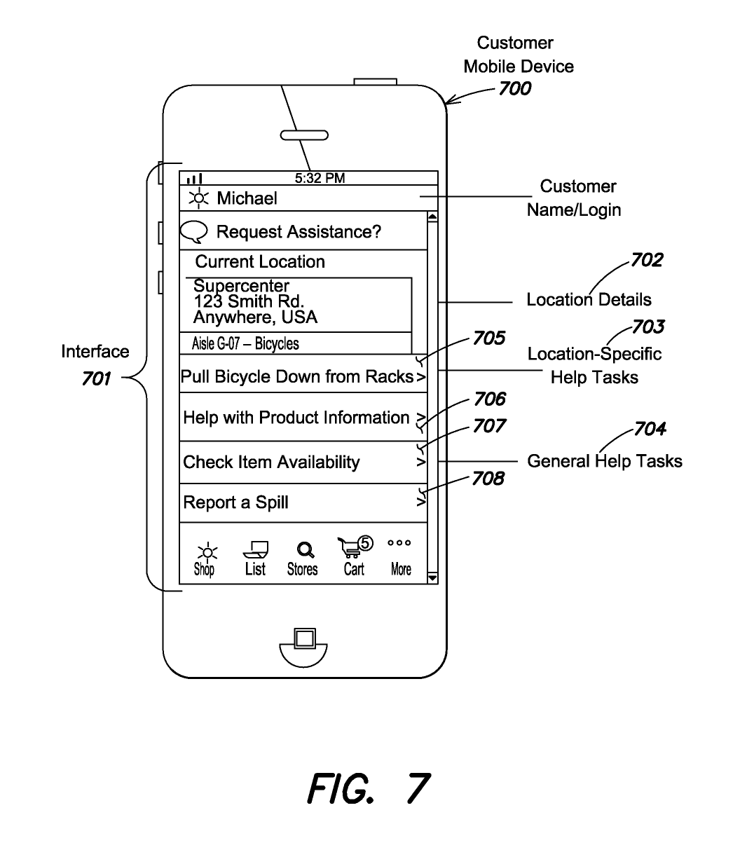

FIG. 7 shows one implementation of an interface that may be implemented by a customer assistance system according to one embodiment of the present invention. In particular, a customer mobile device 700 may include an interface 701 having one or more controls, display areas, and input areas. For instance, within interface 701, a control may be provided, that when selected by the user, allows the user to request assistance.

As discussed above, the mobile device may determine the customer's location within the store, and according to one embodiment, the assistance context may be changed within the interface depending on the location. For instance, the mobile device 700 may determine the customer's location, and the mobile device may determine that it is located within a particular store. Such location information details (e.g., location details 702) may be displayed within the interface 701. The location information displayed may also include more specific information within the store, such as an aisle location within the store.

Based on the customer's location, there may be one or more location-specific help tasks (e.g., tasks 703) that could be displayed to the customer within interface 701. For example, a task “Pull Bicycle Down From Racks” may be displayed if the customer (e.g., a customer “Michael”) is located near the bicycle area. Depending on the customer's proximity to a particular location, certain assistance options may be displayed. That is, tasks associated with closer areas or locations will be ranked higher and displayed within interface 701.

Further, general help tasks (e.g., tasks 704) may be displayed within an area of the interface (e.g., area 704) that are common to one or more areas of the store. Such options may be displayed regardless of the other options that may be determined for display. For instance, an area “Help With Product Information” 706 may be displayed that allows the customer to obtain product information while at any store location. For instance, selection of this option may allow the customer to perform a product search within the store, scan a barcode associated with a product, or provide any other input that identifies a product. Such support may be provided by someone at the store location, although other resources outside the store (e.g., a customer assistance group) can be used to satisfy in-store requests in a more efficient manner across a number of store locations.

Other options may be provided, such as “Check Item Availability” 707, “Report a Spill” 708, among other options. Some options or displays may allow a customer to input natural language requests for customer service. Such inputs may be received by the customer assistance system, and processed to determine the meaning of the request. The customer assistance system may present further options to the customer to determine the closest match to their needs.

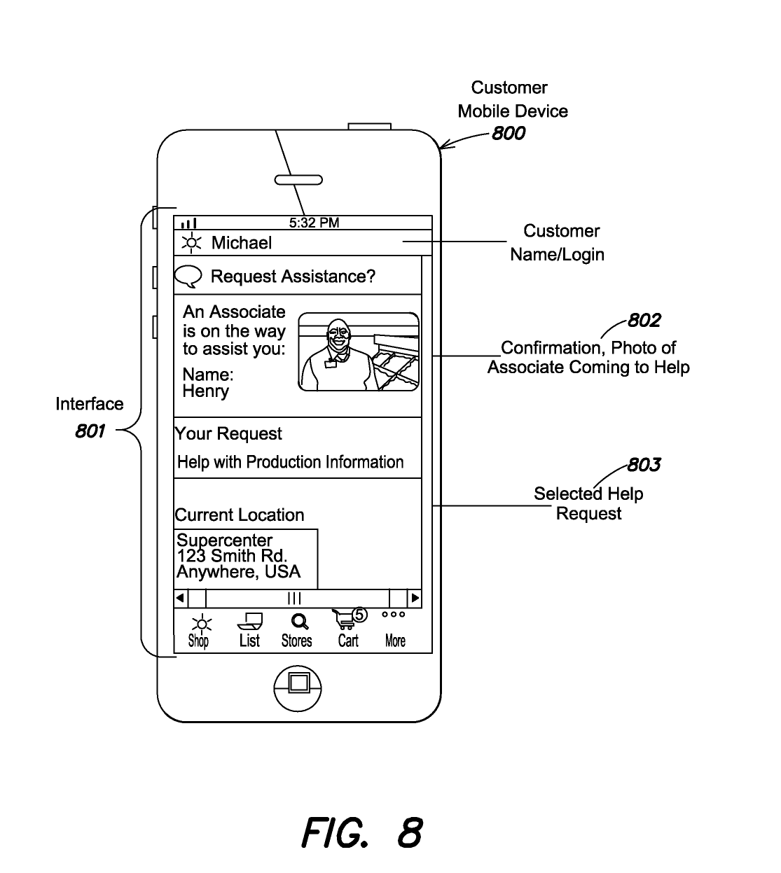

FIG. 8 shows another implementation of an interface that may be implemented by a customer assistance system according to one embodiment of the present invention. In particular, an interface 801 may be presented on a customer's mobile device (e.g., device 800) in which may be displayed one or more controls, display areas, and input areas. Notably, according to one embodiment of the present invention, status information regarding a customer service request may be displayed to the customer indicating the status of the request on their mobile device. For instance, a confirmation 802 of the receipt and assignment of the request to a specific employee may be displayed to the customer. Also, a picture of the employee assigned to assist the customer may be provided within the display to allow the customer to recognize the employee. Also, an employee's name may be displayed. Other information, such as information 803 identifying the selected help request may be displayed to the customer/user within the display.

It should be appreciated that other interfaces may be provided that permit the customer to enter and receive customer assistance information that are within the spirit and scope of the present invention. For instance, there may be additional interfaces presented after the customer service was rendered to accept feedback regarding the customer's assistance experience. For instance, there may be presented one or more rankings of the employee's performance in one or more areas, and that information may be automatically collected by the system to perform employee assessment or to determine overall company performance in the area of customer service. In another example, the system may collect feedback regarding a number of employees (e.g., per department, per store, etc.) so that assessments can be made by management personnel. Notably, management that supports multiple store locations can view performance information in real time to determine adequate allocation of resources.

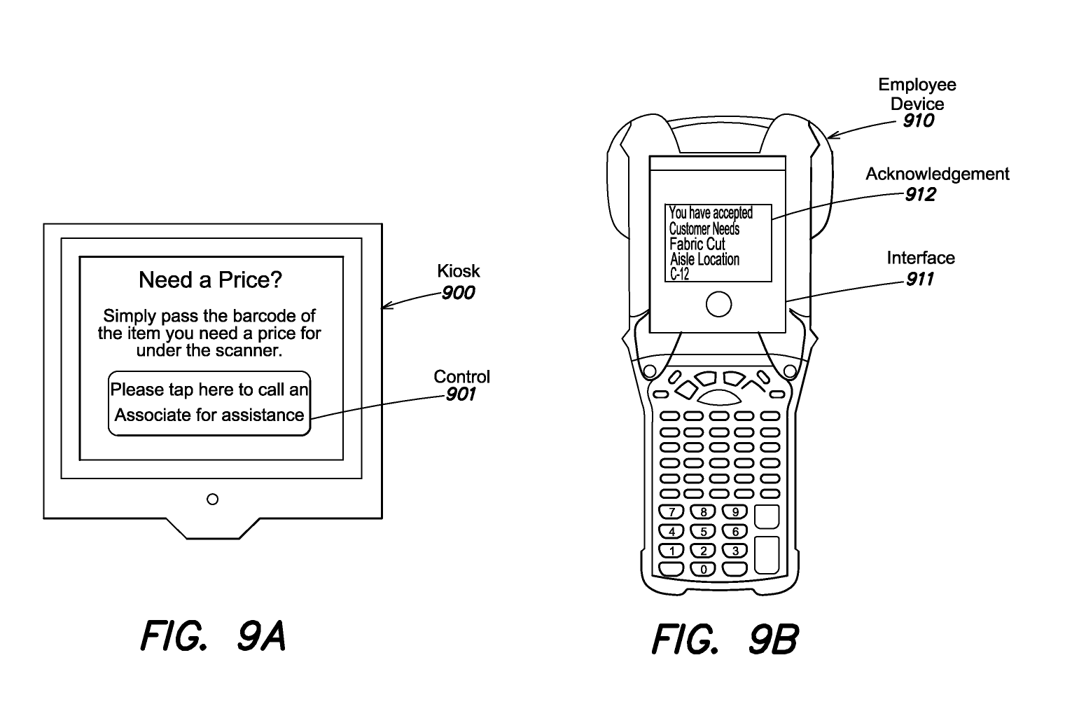

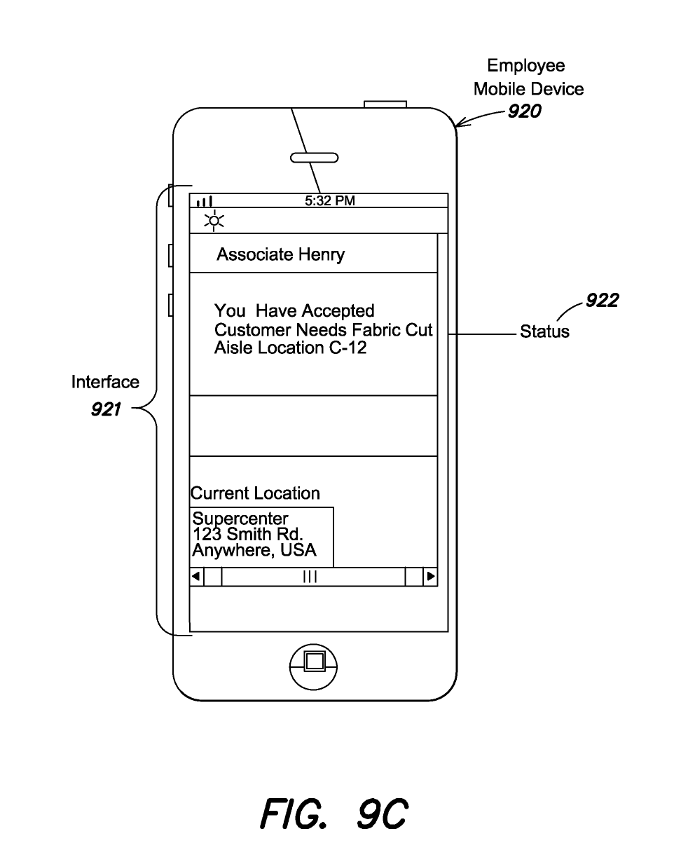

FIGS. 9A-9C show additional systems that may be used according to various embodiments of the present invention. For instance, it should be appreciated that existing systems may be leveraged to achieve various aspects of the present invention. For instance, a price checking kiosk 900 may be modified to provide additional customer assistance options. For instance, a control 901 may be added to a price checking kiosk to permit the customer to request employee assistance. To this end, such kiosks may be integrated with a customer assistance system according to various aspects of the present invention. In FIG. 9B, a task-based employee device 910 may be used to communicate customer service requests and information to store employees. Such systems may be traditionally used for communicating tasks between management and employees for the purpose of assigning in-store tasks. Such systems may be leveraged to also support customer service requests. In one example, such a system may be modified to display controls associated with customer assistance options, acknowledgements for assigned tasks (e.g., acknowledgement message 912 within interface 911), among other additional functions related to servicing customer service requests.

As shown in FIG. 9C, a customer assistance system according to one embodiment may be adapted to communicate to employees using their existing mobile devices, such as an employee mobile device 920 (e.g., a cell phone, smart device, etc.). For instance, an application may be provided to communicate with the customer assistance system, and the application may include an interface (e.g., interface 921) through which the employee may accept tasks, view statuses (e.g., status 922), scan location codes, or perform other customer assistance functions. In another embodiment, the customer assistance system may communicate with employee mobile devices using standard methods, such as SMS messaging, emails, or other communication methods.

It should be appreciated that other use cases may be possible using various aspects of the present invention either within a retail setting, or in other lines of commerce. For instance, a customer assistance system may be used in conjunction with a taxi/cab service, wherein a poster including a code is posted outside of a restaurant, club, or other location that, when scanned by a customer using their mobile device, contacts a cab company to order a cab to the location encoded in the displayed code.

Other example implementations are possible. For instance, in a restaurant setting, a customer may be permitted to scan a code at a particular table, and then enter their order. Further, the code may be scanned to call a waiter/waitress, manager, or other employee to help. Additionally, a customer may order menu items by scanning their QR or other type of codes printed on the menu, may receive additional information regarding their menu items by scanning the item codes, or perform other operations using a scanning method.

In a meeting room reservation system, a user may scan a code posted outside of the room to book the meeting room. In a car reservation and selection system, a customer may select a particular car within the parking lot without having to walk into an office to do so—the customer may scan a code posted on the car or in a particular space. The customer assistance system may be configured to provide an unlock code to the customer if the car is locked and includes a combination keypad. The customer may be permitted to unlock the car and drive away without any additional employee interactions. Alternatively, a remote management system such as OnStar, Microsoft SYNC, or other system may be used to unlock the car.

In a car sales lot scenario, after the customer finds a car he/she likes, the customer may be permitted to scan a code posted on the car (or lot location) to get a salesperson to meet the customer at the car location for assistance. Such a system may reduce the amount of sales pressure on the customer and allows the customer to engage the salesperson when they need assistance, reducing the amount of time that they are waiting for help and reducing any excess walking needed to locate a salesperson.

In another example, a customer may use a scan code or other location-based entry to obtain customer assistance loading or unloading items from a vehicle. For instance, a customer may obtain assistance using their mobile device at a lumber yard, a donation drop off location, an outdoor garden center, or other location. It should be appreciated that aspects of the present invention need not be performed within a retail store, but rather aspects may be performed at any location where service could be rendered. For instance, an emergency medical technician can respond to an accident help request at any location (e.g., a patient's home, the street, etc.). Further, it should be appreciated that aspects of the present invention are not limited to being responded to by employees. For instance, a responder could be a third party person not employed by the store, could be a volunteer, another customer, etc. Also, it should be appreciated that the receiver of the service need not be an actual customer, but rather, it could be any entity capable of receiving a service.

### Example Computer Implementations

Processes described above are merely illustrative embodiments of systems that may be used to provide customer assistance at a store location. Such illustrative embodiments are not intended to limit the scope of the present invention, as any of numerous other implementations for performing the invention. None of the claims set forth below are intended to be limited to any particular implementation of a customer assistance system, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to perform customer assistance functions according to various embodiments of the invention. Further, the software design system may be located on a single computer or may be distributed among a plurality of computers (e.g., mobile phones) attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system and many operating systems may be used and supported.

Some aspects of the invention may be implemented as distributed application components that may be executed on a number of different types of systems coupled over a computer network. Some components may be located and executed on mobile devices, servers, tablets, or other system types. Other components of a distributed system may also be used, such as databases (e.g., the mongoDB database available from 10gen, Inc.), cloud services, or other component types.

The processor and operating system together define a computer platform for which application programs in high-level programming languages are written. It should be understood that the invention is not limited to a particular computer system platform, processor, operating system, or network. Further, it should be appreciated that multiple computer platform types may be used in a distributed computer system that implements various aspects of the present invention. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. In other implementations, various aspects may be performed in an ASP (application service provider), SAS (software as a service), distributed application or other type of software model application. Such software components may be executable, intermediate (e.g., IL) or interpreted (e.g., Java) code which communicate over a communication network (e.g., the Internet) using a communication protocol (e.g., TCP/IP). Certain aspects of the present invention may also be implemented on a cloud-based computer system (e.g., the EC2 cloud-based computing platform provided by Amazon.com), a distributed computer network, or any combination of systems.

It should be appreciated that the invention is not limited to executing on any particular system or group of systems. Also, it should be appreciated that the invention is not limited to any particular distributed architecture, network, or communication protocol.

Further, on each of the one or more computer systems that include one or more components of distributed system 100, each of the components may reside in one or more locations on the system. For example, different portions of the components of system 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

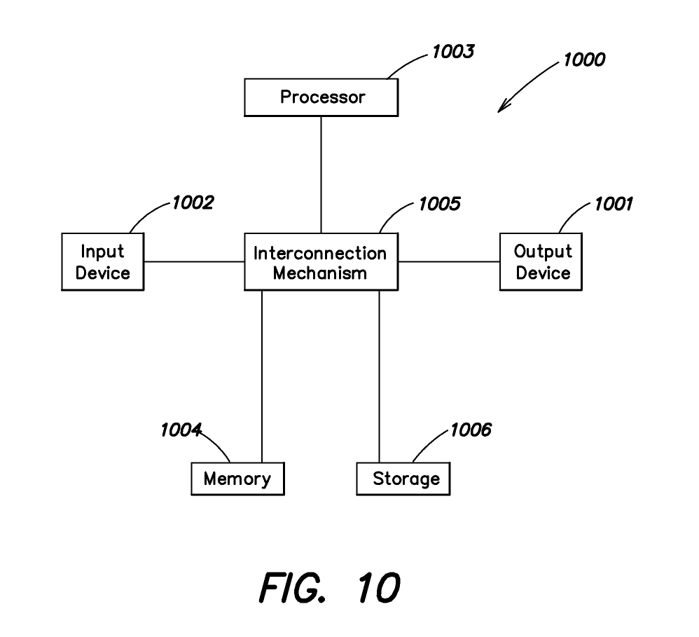

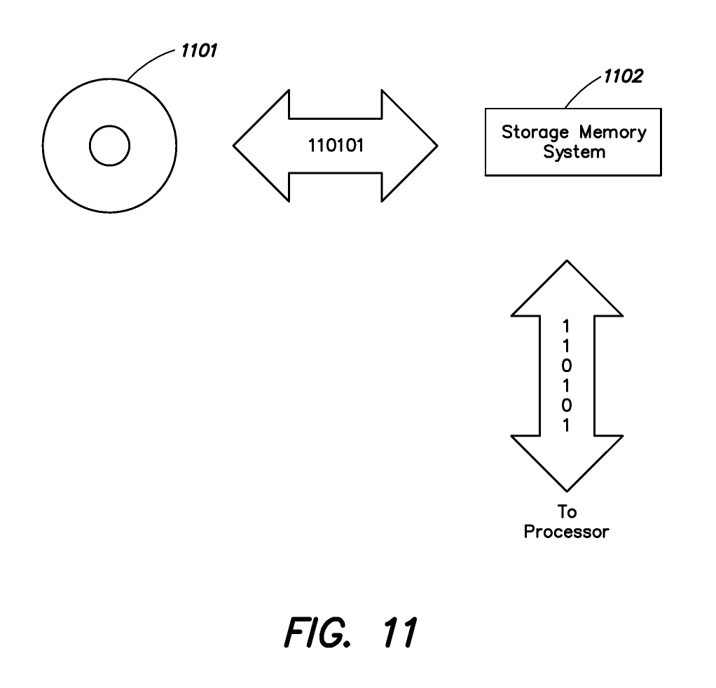

Any number of systems of system 100 may be implemented on a computer system described below in relation to FIGS. 10 and 11. In particular, FIG. 10 shows an example computer system 1000 used to implement various aspects. FIG. 11 shows an example storage system that may be used.

System 1000 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

For example, various aspects of the invention may be implemented as specialized software executing in a general-purpose computer system 1000 such as that shown in FIG. 10. The computer system 1000 may include a processor 1003 connected to one or more memory devices 1004, such as a disk drive, memory, or other device for storing data. Memory 1004 is typically used for storing programs and data during operation of the computer system 1000. Components of computer system 1000 may be coupled by an interconnection mechanism 1005, which may include one or more busses (e.g., between components that are integrated within a same machine) and/or a network (e.g., between components that reside on separate discrete machines). The interconnection mechanism 1005 enables communications (e.g., data, instructions) to be exchanged between system components of system 1000. Computer system 1000 also includes one or more input devices 1002, for example, a keyboard, mouse, camera, scanner, trackball, microphone, touch screen, and one or more output devices 1001, for example, a printing device, display screen, and/or speaker. The system may also include any specialized components depending on the application, including any barcode reader, magnetic stripe reader, receipt printer, hand-held, integrated or fixed scanners, pin entry devices (PED), or other device types. In addition, computer system 1000 may contain one or more interfaces (not shown) that connect computer system 1000 to a communication network (in addition or as an alternative to the interconnection mechanism 1005).

The storage system 1006, shown in greater detail in FIG. 11, typically includes a computer readable and writeable nonvolatile recording medium 1101 in which signals are stored that define a program to be executed by the processor or information stored on or in the medium 1101 to be processed by the program. The medium may, for example, be a disk or flash memory. Typically, in operation, the processor causes data to be read from the nonvolatile recording medium 1101 into another memory 1102 that allows for faster access to the information by the processor than does the medium 1101. This memory 1102 is typically a volatile, random access memory such as a dynamic random access memory (DRAM) or static memory (SRAM). It may be located in storage system 1006, as shown, or in memory system 1004, not shown. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is not limited to a particular memory system 1004 or storage system 1006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architecture or components that that shown in FIG. 10.

Computer system 1000 may be a general-purpose computer system that is programmable using a high-level computer programming language. Computer system 1000 may be also implemented using specially programmed, special purpose hardware. In computer system 1000, processor 1003 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 7 or Windows 8 operating systems available from the Microsoft Corporation, MAC OS Snow Leopard, MAC OS X Lion operating systems available from Apple Computer, the Solaris Operating System available from Sun Microsystems, iOS, Blackberry OS, Windows 7 or 8 Mobile or Android OS operating systems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for assisting a customer at a location, the system comprising:
a computer system having:
a memory;
a processor coupled to the memory;
a location component configured to determine a location of a customer; and
an interface having a control that, activated by a customer, contacts a customer assistance system.

2. The system according to claim 1, wherein the computer system includes a mobile device of the customer.

3. The system according to claim 2, wherein the mobile device includes a component adapted to scan a code associated with the location.

4. The system according to claim 3, wherein the component adapted to scan a code is responsive to the customer selecting a control that scans the code.

5. The system according to claim 1, wherein the location component configured to determine the location of the customer includes at least one of a group of systems used to determine the location comprising at least one of a Wi-Fi component, a GPS component, a network-based location component, an image processing component, and a node-based location component.

6. The system according to claim 1, wherein the location component is adapted to identify the location of the customer based on a location of a system used to contact the customer assistance system.

7. The system according to claim 3, wherein the code associated with the location is a preprinted code that is displayed near the location.

8. The system according to claim 3, wherein the location is a store location, and wherein the code encodes at least one of a group of information comprising a store location, a store department, an aisle location, a location proximate the store location, a physical location associated with the store and a logical location associated with the store.

9. The system according to claim 1, wherein the location includes at least one of a group comprising a street address, a poll number, a descriptive address, and a relative location.

10. The system according to claim 1, further comprising an interface adapted to provide location information of the customer to the customer assistance system.

11. The system according to claim 10, wherein the customer assistance system is adapted to provide one or more assistance options to the user based on the determined location.

12. The system according to claim 11, wherein the interface is adapted to present the one or more assistance options to the customer within a display.

13. The system according to claim 12, wherein the interface includes a control that is configured to accept a choice of the one or more assistance options.

14. The system according to claim 13, wherein the interface is adapted to receive an input from the customer describing the assistance that is needed.

15. The system according to claim 13, wherein the customer assistance system is adapted to determine, based on the choice of the one or more assistance options, one or more support resources to fulfill the chosen option.

16. The system according to claim 15, wherein the one or more support resources include at least one employee.

17. The system according to claim 16, wherein the customer assistance system is adapted to determine the at least one available store employee based on their on-the-clock availability.

18. The system according to claim 15, wherein the customer assistance system is adapted to assign one or more support resources to fulfill the chosen option.

19. The system according to claim 15, wherein the one or more support resources includes personnel resources located at the location.

20. The system according to claim 15, wherein the one or more support resources includes personnel resources located outside of the location.

21. The system according to claim 18, further comprising an interface to a system that assigns at least one task to an employee to be performed to assist the customer.

22. The system according to claim 18, further comprising a component that is adapted to indicate a status of the at least one task to an employee to be performed to assist the customer.

23. The system according to claim 18, wherein the customer assistance system is adapted to send a request to a task-based employee management system.

24. The system according to claim 23, wherein the customer assistance system is adapted to send a notification of the at least one task to an employee-based system of an employee assigned to the at least one task.

25. The system according to claim 15, wherein the customer assistance system is adapted to determine one or more support resources to fulfill the support option responsive to data indicating a capability of an employee to fulfill the chosen assistance option.

26. The system according to claim 24, further comprising a component that allows the employee to accept the at least one task.

27. The system according to claim 24, wherein the interface is adapted to display information regarding the employee assigned to the at least one task.

28. The system according to claim 27, wherein the interface is adapted to display a picture of the employee assigned to the at least one task.

29. The system according to claim 28, wherein the identification of the employee includes at least one of a name of the employee and a picture of the employee.

30. The system according to claim 24, customer assistance system is adapted to determine a performance of the at least one task.

31. The system according to claim 15, wherein the customer assistance system is adapted to monitor and store performance information relating to the support resources.

32. The system according to claim 31, wherein the customer assistance system includes an interface that is adapted to report the performance information relating to the support resources.

33. The system according to claim 32, wherein the customer assistance system is adapted to determine at least one of a group comprising:
a trend of assistance requests;
a trend of types of assistance requests;
a performance of at least one employee that handled one or more assistance requests; and
a performance of a group of employees that handled one or more assistance requests.

34. The system according to claim 32, wherein the customer assistance system is adapted to report the performance of one or more stores.

35. The system according to claim 32, wherein the customer assistance system is adapted to determine an allocation of resources to different store locations.

36. The system according to claim 1, wherein the location component is configured to determine a location of a customer within a store.

37. The system according to claim 30, wherein the performance of the at least one task includes at least one of a measurement of a statistic related to the performance of the at least one task.

38. The system according to claim 30, wherein the performance of the at least one task includes at least one of an indication that the at least one task was performed.

39. The system according to claim 18, further comprising an interface to a system that presents at least one task that is capable of being accepted by the employee.

40. The system according to claim 15, wherein the one or more support resources include a responder.

41. The system according to claim 12, wherein the options displayed are prioritized based on the number of previous requests made from that location.

42. The system according to claim 41, wherein the options displayed are further prioritized based on the number of previous requests made at a similar time of day as the current request.

43. The system according to claim 42, wherein the options displayed are further prioritized based on the number of previous requests made on the same day of the week as the current request.

44. The system according to claim 1, wherein the interface is adapted to display a map including an indication of the location of the customer.

45. The system according to claim 44, wherein the interface is adapted to display, on the map, an indication of a location of an employee assigned to a customer service request.

46. A method for assisting a customer at a location, the method comprising acts of:
determining a location of a customer;
presenting, within an interface of a computer system, a control; and
contacting a customer assistance system responsive to a customer activating the control.

47. The method according to claim 46, wherein the computer system includes a mobile device of the customer.

48. The method according to claim 47, wherein the mobile device includes a component adapted to scan a code associated with the location of the customer, and the method further comprises an act of determining the location of the code responsive to a scanning of the code by the mobile device.

49. The method according to claim 48, wherein the component adapted to scan a code is responsive to the customer selecting a control that scans the code.

50. The method according to claim 46, wherein the act of determining the location of the customer comprises at least one of a group comprising determining the customer location using Wi-Fi, determining the customer location using GPS, determining the customer location using network-based location methods, determining the customer location using image processing, determining the customer location using optical methods, and determining the customer location using node-based location methods.

51. The method according to claim 46, further comprising an act of identifying the location of the customer based on a location of a system used to contact the customer assistance system.

52. The method according to claim 48, wherein the code associated with the location is a preprinted code that is displayed near the location.

53. The method according to claim 48, wherein the location is a store location, and wherein the code encodes at least one of a group of information comprising a store location, a store department, an aisle location, a location proximate the store location, a physical location associated with the store and a logical location associated with the store.
